(19) United States
(12) Patent Application Publication
(10) Pub. No.: US 2025/0305845 A1
(43) Pub. Date: Oct. 2, 2025

(54) METHOD AND SYSTEM FOR DISPLAYING 3-DIMENSIONAL VIRTUAL ENVIRONMENT INFORMATION FOR AUTONOMOUS DRIVING SIMULATION

(71) Applicant: MORAI INC., Seoul (KR)

(72) Inventors: .Taehyun .SONG, Seoul (KR); Jiyoon JANG, Seoul (KR)

(21) Appl. No.: 19/237,591

(22) Filed: Jun. 13, 2025

Related U.S. Application Data
(63) Continuation of application No. PCT/KR2023/017202, filed on Nov. 1, 2023.

(30) Foreign Application Priority Data
Dec. 15, 2022 (KR) 10-2022-0175692

(51) Int. Cl. G01C 21/36; G06F 3/04842

(52) U.S. Cl. CPC G01C 21/3638; G01C 21/3658; G06F 3/04842

(57) ABSTRACT

A method for displaying three-dimensional virtual environment information for autonomous driving simulation includes rendering a three-dimensional virtual environment for a specific region based on high-definition road map data representing road information of the specific region, and outputting the rendered three-dimensional virtual environment on a display of the user terminal, outputting, on the display, a vehicle traveling using an autonomous driving algorithm within the three-dimensional virtual environment, and visualizing and outputting, within the rendered three-dimensional virtual environment on the display, at least a portion of metadata included in the high-definition road map data.

### CROSS-REFERENCE TO RELATED APPLICATION

This application is a continuation of International Application No. PCT/KR2023/017202 filed on Nov. 1, 2023, which claims priority to Korean Patent Application No. 10-2022-0175692 filed on Dec. 15, 2022, the entire contents of which are herein incorporated by reference.

### BACKGROUND

The present disclosure relates to a method and system for displaying three-dimensional virtual environment information for autonomous driving simulation, and more particularly, to a method and system for visualizing and outputting, within a rendered three-dimensional virtual environment, metadata included in high-definition road map data.

### DESCRIPTION OF RELATED ART

Autonomous driving technology refers to technology that can autonomously drive a vehicle with minimal or no human intervention by recognizing the surrounding environment using radar, light detection and ranging (LiDAR), global positioning system (GPS), cameras, and the like. Because numerous elements that affect autonomous driving exist (e.g., vehicles and traffic structures in road areas and buildings in roadside areas) an enormous amount of testing is required to secure full autonomous driving functionality without human intervention.

Because autonomous-driving tests in real driving environments have limitations, attempts to construct virtual environments corresponding to real driving environments and test autonomous driving therein are increasing. However, contemporary virtual environments for autonomous driving require significant time and cost because data must be manually cleaned, mapped, and three-dimensionally modeled. In particular, during testing of autonomous driving in a virtual environment, a developer must directly search for source data and/or metadata corresponding to an object to verify errors in the autonomous-driving simulation, which is cumbersome.

### SUMMARY

Various aspects of the present disclosure can be implemented in multiple ways, including as a method, as an apparatus (system), or as a computer-readable storage medium storing a computer program.

In some aspects, a method for displaying three-dimensional virtual environment information for autonomous driving simulation, performed by at least one processor of a user terminal, includes rendering a three-dimensional virtual environment for a specific region based on high-definition road map data representing road information of the specific region, and outputting the rendered three-dimensional virtual environment on a display of the user terminal, outputting, on the display, a vehicle traveling using an autonomous driving algorithm within the three-dimensional virtual environment, and visualizing and outputting, within the rendered three-dimensional virtual environment on the display, at least a portion of metadata included in the high-definition road map data.

In some aspects, the metadata visualized within the rendered three-dimensional virtual environment may include at least one of a link, a node, and a link identifier. The node may be visualized as a sphere, the link may be visualized as a line connecting two nodes, and the link may represent a route along which the vehicle may travel (e.g., is configured to travel) without changing lanes.

In some aspects, visualizing and outputting at least the portion of the metadata within the rendered three-dimensional virtual environment on the display further may include displaying at least some of a plurality of link identifiers included in the high-definition road map data in a first region of the display, receiving a first user input selecting a specific link identifier from the first region of the display, and in response to receiving the first user input, rendering, in a second region of the display, a three-dimensional virtual environment near the selected specific link, and visualizing and displaying the specific link and an identifier of the specific link.

In some aspects, visualizing and outputting at least the portion of the metadata within the rendered three-dimensional virtual environment on the display may further include displaying, in a third region of the display, nodes associated with the specific link and information of other links connected to the specific link.

In some aspects, visualizing and outputting at least the portion of the metadata within the rendered three-dimensional virtual environment on the display may further include displaying, in a fourth region of the display, traffic light information associated with the specific link, and the traffic light information associated with the specific link may include a traffic light identifier and a lighting state of a traffic light.

In some aspects, visualizing and outputting at least the portion of the metadata within the rendered three-dimensional virtual environment on the display may further include receiving a second user input associated with adjusting transparency of the visualized metadata, and in response to receiving the second user input, displaying, in the second region of the display, remaining visualized links except for the specific visualized link with transparency adjusted to a predefined value.

In some aspects, the metadata visualized within the rendered three-dimensional virtual environment may further include a virtual link, and the virtual link represents a path along which the vehicle may perform (e.g., is configured to perform) a lane change.

In some aspects, a color of the specific link visualized in the second region of the display differs from a color of other visualized links connected to the specific visualized link, all nodes visualized in the second region of the display are visualized as spheres of an identical color, the specific link is visualized at a first height above a road surface, nodes associated with the specific link are visualized at a second height above the road surface, an identifier of the specific link is visualized at a third height above the road surface, the first height and the second height are identical, and the third height is greater than the first height.

In some aspects, a non-transitory computer-readable recording medium may store instructions for execution by one or more processors that, when executed by the one or more processors, cause the one or more processors to perform the above mentioned methods.

In some aspects, a user terminal includes a communication device, a memory, a display, and at least one processor coupled to the memory and configured to execute at least one computer-readable program stored in the memory. The at least one program includes instructions for rendering a three-dimensional virtual environment for a specific region based on high-definition road map data representing road information of the specific region, and outputting the rendered three-dimensional virtual environment on the display of the user terminal, outputting, on the display, a vehicle traveling using an autonomous driving algorithm within the three-dimensional virtual environment, and visualizing and outputting, within the rendered three-dimensional virtual environment on the display, at least a portion of metadata included in the high-definition road map data.

### BRIEF DESCRIPTION OF THE DRAWINGS

Embodiment(s) of the present disclosure will be described below with reference to the accompanying drawings, wherein like reference numerals designate like elements, but are not limited thereto.

FIG. 1 illustrates an example of displaying three-dimensional virtual environment information for autonomous driving simulation according to an example of the present disclosure.

FIG. 2 is a schematic diagram illustrating a configuration in which an information-processing system is connected so as to communicate with a plurality of user terminals to provide an autonomous-driving-simulation service according to an example of the present disclosure.

FIG. 3 is a block diagram illustrating internal configurations of a user terminal and an information-processing system according to an example of the present disclosure.

FIG. 4 illustrates an example of generating a travel route along which a non-player-controlled (NPC) vehicle can travel, based on high-definition road map data according to an example of the present disclosure.

FIG. 5 illustrates an example of creating traffic lights in a three-dimensional virtual environment based on high-definition road map data according to an example of the present disclosure.

FIG. 6 illustrates an example in which metadata is visualized and displayed in a three-dimensional virtual environment according to an example of the present disclosure.

FIG. 7 illustrates an example of adjusting transparency of visualized metadata according to an example of the present disclosure.

FIG. 8 illustrates an example in which traffic-light information is displayed in a three-dimensional virtual environment according to an example of the present disclosure.

FIG. 9 illustrates an example in which virtual links are displayed in a three-dimensional virtual environment according to an example of the present disclosure.

FIG. 10 illustrates an example of displaying links and nodes in a three-dimensional virtual environment according to an example of the present disclosure.

FIG. 11 is a flowchart illustrating an example of a method for displaying three-dimensional virtual environment information according to an example of the present disclosure.

### DETAILED DESCRIPTION

According to various embodiment(s) of the present disclosure, a user may conveniently check metadata visualized in the rendered three-dimensional virtual environment. In addition, when there is a problem with traveling (or driving) using the autonomous-driving algorithm within the three-dimensional virtual environment, the user may easily determine, through the visualized metadata, which high-definition road map data is problematic. Accordingly, the time required to identify and resolve causes of simulation errors can be shortened.

According to various aspects of the present disclosure, by visualizing metadata, the user may easily confirm how the metadata is implemented on the three-dimensional virtual environment. In addition, the user may conveniently confirm information associated with a specific link using a metadata-viewer interface. Furthermore, by checking a location of a specific link in the three-dimensional virtual environment, the user may promptly determine whether an error that occurred during traveling using the autonomous-driving algorithm was caused by the high-definition road map data or by another issue.

According to various aspects of the present disclosure, the user may easily confirm, on a screen on which the three-dimensional virtual environment is rendered, a traffic light connected with a specific link in the three-dimensional virtual environment and a lighting state thereof. In addition, the user may easily confirm whether the autonomous-driving vehicle correctly travels with respect to the traffic light at an intersection.

According to various aspects of the present disclosure, the user may readily distinguish, in the three-dimensional virtual environment, between a planned travel route of the vehicle and visualized links according to a height from a ground surface. Moreover, because a visualized link identifier is displayed higher than the visualized link with reference to the ground surface, the user may more easily identify the link identifier.

The effects of the present disclosure are not limited to the above-mentioned effects, and other effects not mentioned herein will be clearly understood by those of ordinary skill in the art from the description of the appended claims.

Hereinafter, specific contents for implementing the present disclosure will be described in detail with reference to the accompanying drawings. In the following description, detailed descriptions of well-known functions or configurations that may obscure the gist of the present disclosure will be omitted.

In the accompanying drawings, identical or corresponding components are denoted by identical reference numerals. In the descriptions below, repetitive descriptions of identical or corresponding components may be omitted. However, omission of descriptions regarding components does not intend to indicate that such components are not included in an embodiment.

Advantages, features, and methods of achieving them in disclosed implementations will become apparent with reference to the implementations described below and the accompanying drawings. However, the present disclosure is not limited to the disclosed implementations but may be implemented in various other forms, and the implementations are merely provided so that the present disclosure is thorough and fully conveys the scope of the disclosure to those of ordinary skill in the art.

Terms used herein will be briefly described and the disclosed implementations will be described in detail. Terms used in the present specification have been selected from widely used general terms in consideration of the functions of the present disclosure; however, meanings may vary depending on the intention of a person skilled in the art, precedents, or the emergence of new technology. In specific cases, terms arbitrarily selected by an applicant may be used, in which case meanings thereof will be described in detail in relevant portions of the description. Accordingly, terms used herein should be defined based on meanings of the terms and overall content of the present disclosure rather than simple titles of the terms.

Unless explicitly stated to the contrary in context, a singular expression in the present specification includes a plural expression, and a plural expression includes a singular expression. Throughout the specification, when a portion is said to “include” a component, this indicates that other components are not excluded but may be further included unless otherwise specified.

The terms “module” or “unit” used in the specification refer to software or hardware components that perform a role. However, a “module” or “unit” is not limited to software or hardware. A “module” or “unit” may be configured to reside in an addressable storage medium and may be configured to reproduce one or more processors. Therefore, by way of example, a “module” or “unit” may include at least one of software components, object-oriented software components, class components, and task components; processes; functions; attributes; procedures; subroutines; program-code segments; drivers; firmware; microcode; circuits; data; databases; data structures; tables; arrays; or variables. Functions provided by components, “modules,” or “units” within may be combined into fewer components, “modules,” or “units” or separated into additional components, “modules,” or “units.”

According to the present disclosure, a “module” or “unit” may be implemented by a processor and a memory. The “processor” should be broadly interpreted as including a general-purpose processor, a central processing unit (CPU), a microprocessor, a digital signal processor (DSP), a controller, a microcontroller, or a state machine. In some environments, the “processor” may refer to an ASIC, a programmable logic device (PLD), a field-programmable gate array (FPGA), or the like. The “processor” may also refer to a combination of processing devices, such as a combination of a DSP and a microprocessor, a combination of multiple microprocessors, a combination of one or more microprocessors coupled with a DSP core, or any other such configuration. The “memory” should be broadly interpreted as including any electronic component capable of storing electronic information. The “memory” may refer to various types of processor-readable media such as random-access memory (RAM); read-only memory (ROM); non-volatile RAM (NVRAM); programmable ROM (PROM); erasable PROM (EPROM); electrically erasable PROM (EEPROM); flash memory; magnetic or optical data storage devices; registers; and the like. If a processor can read from and/or write to the memory, the memory is said to be in electronic communication with the processor. When a memory is integrated in a processor, the memory is in electronic communication with the processor.

In the present disclosure, a “system” may include at least one of a server device and a cloud device but is not limited thereto. For example, the system may be constituted by one or more server devices. As another example, the system may be constituted by one or more cloud devices. In yet another example, the system may be operated in a combined configuration of a server device and a cloud device.

In the present disclosure, a “display” may refer to any display device associated with a computing device, for example, any display device capable of displaying any information/data controlled by or provided from the computing device.

In the present disclosure, “each of a plurality of A” or “respective ones of a plurality of A” may refer to each of all components included in the plurality of A or each of some components included in the plurality of A.

In the present disclosure, a “link” may refer to a straight or curved line that defines a route along which a vehicle may proceed without changing lanes, included in high-definition road map data. Additionally, a “link” may include direction data associated with the line. A link may include a vehicle-travel link, which represents a route along which the vehicle may proceed without changing lanes, and a pedestrian link, which represents a route along which a person may walk. A link may refer to a vehicle-travel link and/or a pedestrian link.

In the present disclosure, a “node” refers to a connection point of travel-route links and may be generated at a stop line, a point of entry/exit, a point at which turning occurs, a tunnel, a bridge, an underpass, an overpass, a start/end point of a toll gate, or the like.

In the present disclosure, a “vertex” may refer to a point, a set of points (point cloud), or a peak included in the data of a high-definition road map or the data of a three-dimensional virtual environment.

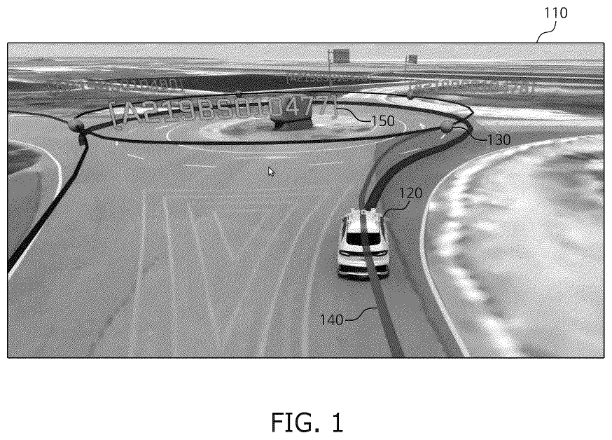

FIG. 1 illustrates an example of displaying three-dimensional virtual environment information for autonomous driving simulation according to an example of the present disclosure. As shown, a three-dimensional virtual environment 110, rendered based on high-definition road map data representing road information of a specific region, may be output on a display of a user terminal. In addition, a vehicle 120 traveling within the three-dimensional virtual environment using an autonomous-driving algorithm may be output on the display.

In an example, at least a portion of metadata included in the high-definition road map data may be visualized within the rendered three-dimensional virtual environment 110. Here, the metadata to be visualized may include links, nodes, link identifiers, traffic-light identifiers, and the like. A visualized node 130 may be displayed as a sphere. A visualized link 140 may be displayed as a line connecting two visualized nodes. Additionally, a visualized link identifier 150 may be displayed, in text form, at a position higher than the visualized link 140 with reference to a ground surface.

Through this configuration, the user may conveniently check metadata visualized in the rendered three-dimensional virtual environment. In addition, when there is a problem with traveling using the autonomous-driving algorithm within the three-dimensional virtual environment, the user may easily identify, through the visualized metadata, which high-definition road map data is problematic. Accordingly, the time required to identify and resolve causes of simulation errors can be shortened.

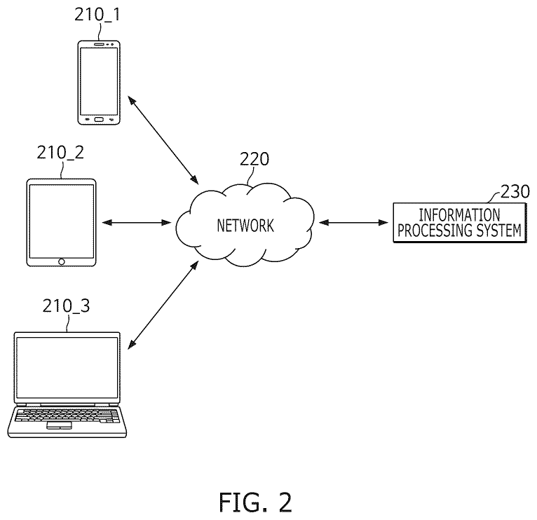

FIG. 2 is a schematic diagram illustrating a configuration in which an information-processing system 230 is connected so as to be communicable with a plurality of user terminals 210_1, 210_2, 210_3 to provide an autonomous-driving-simulation service according to an example of the present disclosure. As shown, the plurality of user terminals 210_1, 210_2, 210_3 may be connected to the information-processing system 230, which can provide an autonomous-driving-simulation service, through a network 220. Here, the plurality of user terminals 210_1, 210_2, 210_3 may include user terminals that receive the autonomous-driving-simulation service.

In an example, the information-processing system 230 may include one or more server devices and/or databases capable of storing, providing, and executing computer-executable programs (for example, downloadable applications) and data related to an autonomous-driving-simulation service, or one or more distributed computing devices and/or distributed databases based on a cloud-computing service.

The autonomous-driving-simulation service provided by the information-processing system 230 may be provided to users through an autonomous-driving-simulation-service application, a web browser, or a web-browser extension program installed in each of the plurality of user terminals 210_1, 210_2, 210_3. For example, the information-processing system 230 may provide information corresponding to a request for visualizing a link identifier or a request for adjusting metadata transparency, which is received from the user terminals 210_1, 210_2, 210_3 through an autonomous-driving-simulation-service application, or may perform corresponding processing.

The plurality of user terminals 210_1, 210_2, 210_3 may communicate with the information-processing system 230 through the network 220. The network 220 may be configured to enable communication between the plurality of user terminals 210_1, 210 2, 210_3 and the information-processing system 230. Depending on an installation environment, the network 220 may be constituted by a wired network, such as Ethernet, a wired home network (power-line communication), telephone-line communication devices, or RS-serial communication; a wireless network, such as a mobile-communication network, a wireless local-area network (WLAN), Wi-Fi, Bluetooth, or ZigBee; or a combination thereof. Communication methods are not limited, and the network 220 may include not only communication methods using communication networks (for example, a mobile-communication network, a wired Internet, a wireless Internet, a broadcast network, or a satellite network) that the network 220 may include, but also short-range wireless communication between user terminals 210_1, 210_2, 210 3.

In FIG. 2, a mobile-phone terminal 210_1, a tablet terminal 210_2, and a personal-computer terminal 210_3 are illustrated as examples of user terminals; however, the present disclosure is not limited thereto, and the user terminals 210_1, 210_2, 210_3 may be any computing device capable of wired and/or wireless communication and capable of executing an autonomous-driving-simulation-service application or a web browser. For example, the user terminal may include an artificial-intelligence (AI) speaker, a smartphone, a mobile phone, a navigation device, a computer, a laptop, a terminal for digital broadcasting, a personal digital assistant (PDA), a portable multimedia player (PMP), a tablet PC, a game console, a wearable device, an Internet-of-Things (IoT) device, a virtual-reality (VR) device, an augmented-reality (AR) device, a set-top box, and the like. In addition, although FIG. 2 shows three user terminals 210_1, 210_2, 210_3 communicating with the information-processing system 230 through the network 220, the present disclosure is not limited thereto, and a different number of user terminals may be configured to communicate with the information-processing system 230 through the network 220.

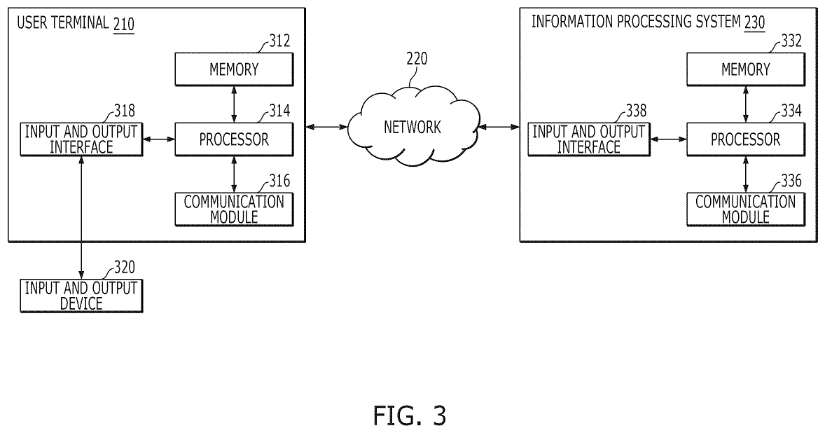

FIG. 3 is a block diagram illustrating internal configurations of the user terminal 210 and the information-processing system 230 according to an example of the present disclosure. The user terminal 210 may refer to any computing device capable of executing an application or a web browser and capable of wired/wireless communication, for example, the mobile-phone terminal 210_1, the tablet terminal 210_2, and the PC terminal 210_3 in FIG. 2. As shown, the user terminal 210 may include a memory 312, a processor 314, a communication module 316, and an input/output interface 318. Likewise, the information-processing system 230 may include a memory 332, a processor 334, a communication module 336, and an input/output interface 338. As shown in FIG. 3, the user terminal 210 and the information-processing system 230 may be configured to communicate information and/or data through the network 220 by using their respective communication modules 316 and 336. In addition, an input/output device 320 may be configured to input information and/or data to the user terminal 210 or output information and/or data generated from the user terminal 210 through the input/output interface 318.

The memories 312 and 332 may include any non-transitory computer-readable recording medium. According to an example, the memories 312 and 332 may include permanent mass-storage devices such as read-only memory (ROM), disk drives, solid-state drives (SSDs), and flash memories. In another example, permanent mass-storage devices such as ROM, SSD, flash memory, and disk drives may be included in the user terminal 210 or the information-processing system 230 as separate permanent storage devices distinguished from the memories. In addition, an operating system and at least one program code may be stored in the memories 312 and 332.

Such software components may be loaded from a computer-readable recording medium separate from the memories 312 and 332. The separate computer-readable recording medium may include a recording medium directly connectable to the user terminal 210 or the information-processing system 230, for example, a computer-readable recording medium such as a floppy drive, a disk, a tape, a DVD/CD-ROM drive, or a memory card. In another example, the software components may be loaded into the memories 312 and 332 through the communication modules 316 and 336 rather than through a computer-readable recording medium. For example, at least one program may be loaded into the memories 312 and 332 based on a computer program installed by files provided through the network 220 by developers or by a file-distribution system that distributes installation files of applications.

The processors 314 and 334 may be configured to process commands of a computer program by performing basic arithmetic, logical, and input/output operations. Commands may be provided to the processors 314 and 334 by the memories 312 and 332 or by the communication modules 316 and 336. For example, the processors 314 and 334 may be configured to execute commands received according to program codes stored in recording devices such as the memories 312 and 332.

The communication modules 316 and 336 may provide configurations or functions for allowing the user terminal 210 and the information-processing system 230 to communicate with each other through the network 220 and may provide configurations or functions for allowing the user terminal 210 and/or the information-processing system 230 to communicate with another user terminal or another system (for example, a separate cloud system). For example, a request or data (for example, a request for visualizing a link identifier or a request for adjusting metadata transparency) generated by the processor 314 of the user terminal 210 according to program codes stored in a recording device such as the memory 312 may be transmitted to the information-processing system 230 through the communication module 316 under control of the communication module and the network 220. Conversely, a control signal or command provided under the control of the processor 334 of the information-processing system 230 may be received by the user terminal 210 through the communication module 336 and the network 220 and through the communication module 316 of the user terminal 210.

The input/output interface 318 may be means for an interface with the input/output device 320. As an example, the input device may include a camera including an audio sensor and/or an image sensor, a keyboard, a microphone, or a mouse, and the output device may include a display, a speaker, or a haptic-feedback device. In another example, the input/output interface 318 may be means for interfacing with a device in which configurations or functions for input and output are integrated into one, such as a touchscreen. For example, when executing commands of a computer program loaded into the memory 312, the processor 314 of the user terminal 210 may display, through the input/output interface 318, a service screen configured by using information and/or data provided by the information-processing system 230 or another user terminal. Although the input/output device 320 is not shown as being included in the user terminal 210 in FIG. 3, the present disclosure is not limited thereto, and the input/output device 320 may be constituted together with the user terminal 210 as a single device. In addition, the input/output interface 338 of the information-processing system 230 may be means for an interface with a device for input or output (not shown) that is connected to or included in the information-processing system 230. In FIG. 3, the input/output interfaces 318 and 338 are illustrated as components separate from the processors 314 and 334; however, the present disclosure is not limited thereto, and the input/output interfaces 318 and 338 may be configured to be included in the processors 314 and 334.

The user terminal 210 and the information-processing system 230 may include more components than those shown in FIG. 3. However, it is not necessary to clearly illustrate the majority of conventional components. In an example, the user terminal 210 may be implemented to include at least some of the above-described input/output devices 320. In addition, the user terminal 210 may further include other components such as a transceiver, a global-positioning-system (GPS) module, a camera, various sensors, and a database. For example, when the user terminal 210 is a smartphone, the user terminal 210 may include components generally included in smartphones, for example, an accelerometer, a gyroscope sensor, a microphone module, a camera module, various physical buttons, buttons using a touch panel, an input/output port, and a vibrator for vibration, which may be further included in the user terminal 210.

While a program for an autonomous-driving-simulation-service application or the like is operating, the processor 314 may receive text, images, videos, audio, and/or actions input or selected through input devices such as a touchscreen, a keyboard, a camera that includes an audio sensor and/or an image sensor, or a microphone connected to the input/output interface 318, and may store the received text, images, videos, audio, and/or actions in the memory 312 or provide them to the information-processing system 230 through the communication module 316 and the network 220.

The processor 314 of the user terminal 210 may be configured to manage, process, and/or store information and/or data received from the input/output device 320, another user terminal, the information-processing system 230, and/or a plurality of external systems. Information and/or data processed by the processor 314 may be provided to the information-processing system 230 through the communication module 316 and the network 220. The processor 314 of the user terminal 210 may transmit information and/or data to the input/output device 320 through the input/output interface 318 to output the data. For example, the processor 314 may display information and/or data received on a screen of the user terminal 210.

The processor 334 of the information-processing system 230 may be configured to manage, process, and/or store information and/or data received from the plurality of user terminals 210 and/or a plurality of external systems. Information and/or data processed by the processor 334 may be provided to the user terminal 210 through the communication module 336 and the network 220.

Although FIGS. 2 and 3 illustrate that the user terminal communicates with the information-processing system through the network and that the information-processing system provides the autonomous-driving-simulation service to the user terminal, the present disclosure is not limited thereto. For example, the user terminal may execute an autonomous-driving-simulation application stored internally without communicating with the information-processing system.

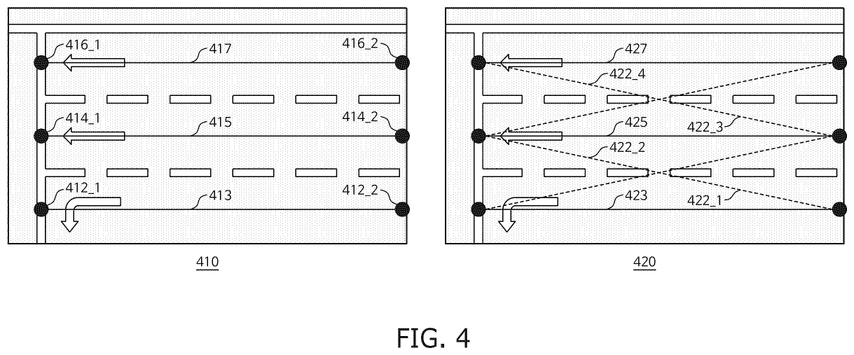

FIG. 4 illustrates an example of generating a travel route along which an NPC vehicle can travel, based on high-definition road map data according to an example of the present disclosure. According to an example, the processor may generate a travel route (or driving route) along which the vehicle can travel based on high-definition road map data. Here, the vehicle may include a vehicle that is a target of autonomous-driving simulation in the three-dimensional virtual environment and surrounding vehicles other than the target. The travel route may include a route along which the vehicle may proceed without changing lanes and a route along which the vehicle may perform a lane change.

Specifically, through a first state 410 and a second state 420, a travel route may be generated based on high-definition road map data. The first state 410 illustrates an example of a state in which the processor has extracted links and/or nodes associated with the travel route based on high-definition road map data. The processor may extract links 413, 415, 417 and/or nodes 412_1, 412_2, 414_1, 414_2, 416_1, 416_2 associated with the travel route from the high-definition road map data. For example, as shown, the processor may extract the link 413 and nodes 412 1, 412_2 associated with a first-lane travel route, the link 415 and nodes 414_1, 414_2 associated with a second-lane travel route, and the link 417 and nodes 416_1, 416_2 associated with a third-lane travel route. Although the first state 410 of FIG. 4 illustrates two nodes and one link for each lane, the present disclosure is not limited thereto, and two or more nodes and a plurality of links connecting the nodes may exist for each lane. Alternatively, the travel route may be defined by links only without nodes.

The second state 420 illustrates an example of a state in which, after the first state 410, the processor has generated a travel route along which the vehicle can travel based on coordinate values and attribute values of the links 413, 415, 417 and/or nodes 412_1, 412_2, 414_1, 414_2, 416_1, 416_2 associated with the travel route. Here, the travel route may include a plurality of links 423, 425, 427 and a plurality of virtual links 422_1, 422_2, 422_3, 422_4. The plurality of links 423, 425, 427 may represent routes along which the vehicle may proceed without changing lanes. The plurality of virtual links 422_1, 422_2, 422_3, 422_4 may represent routes along which the vehicle may perform lane changes.

First, based on the links 413, 415, 417 and/or nodes 412_1, 412_2, 414_1, 414_2, 416_1, 416_2 associated with the travel route extracted from the high-definition road map data, the processor may generate a travel route along which the vehicle can travel for each lane. For example, as shown, a first-lane travel route 423 may be generated based on the link 413 and/or nodes 412_1, 412 2 associated with the first-lane travel route. Likewise, a second-lane travel route 425 may be generated based on the link 415 and/or nodes 414 1, 414_2 associated with the second-lane travel route. In addition, a third-lane travel route 427 may be generated based on the link 417 and/or nodes 416_1, 416_2 associated with the third-lane travel route.

Furthermore, based on the links 413, 415, 417 associated with the travel route and the nodes 412_1, 412_2, 414_1, 414_2, 416_1, 416_2 associated with the links, the processor may generate a travel route along which the vehicle may perform lane changes, that is, virtual links. Specifically, by adding/generating virtual links connecting two adjacent links among a plurality of links associated with each lane, the processor may generate a plurality of virtual links along which the vehicle may perform lane changes. For example, as shown, a first virtual link 422_1 along which a lane change from the first lane to the second lane can be performed may be generated. In addition, a second virtual link 422_2 along which a lane change from the second lane to the first lane can be performed and a third virtual link 422_3 along which a lane change from the second lane to the third lane can be performed may be generated. Additionally, a fourth virtual link 422_4 along which a lane change from the third lane to the second lane can be performed may be generated.

Although the second state 420 of FIG. 4 illustrates virtual links along which lane changes to adjacent lanes can be performed, the present disclosure is not limited thereto, and the virtual links may further include virtual links along which lane changes to non-adjacent lanes within a plurality of lanes in the same direction can be performed. For example, the virtual links may further include a virtual link along which a lane change from the first lane to the third lane can be performed or a virtual link along which a lane change from the third lane to the first lane can be performed. In addition, although FIG. 4 illustrates that lengths of the respective virtual links are identical, the present disclosure is not limited thereto, and virtual links of various lengths may be generated to implement various cases such as sudden lane changes.

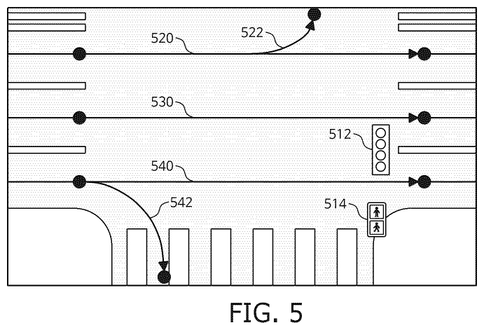

FIG. 5 illustrates an example of creating traffic lights 512 and 514 in a three-dimensional virtual environment based on high-definition road map data according to an example of the present disclosure. According to an example, the processor may place a specific type of traffic light in the three-dimensional virtual environment based on the input high-definition road map data. Here, the specific type of traffic light may refer to data that includes a three-dimensionally rendered result of each type of traffic light and may include attribute values associated with the specific type of traffic light. For example, a vertex associated with a traffic light may include coordinate values and attribute values associated with a four-color traffic light, a three-color traffic light, a pedestrian traffic light, and the like.

Specifically, when an attribute value of a vertex included in the high-definition road map data is associated with a traffic light, the processor may determine the type of traffic light based on the attribute value and may place a three-dimensional object of the traffic light of the determined type at a position corresponding to the coordinate values of the vertex. For example, as shown, the processor may determine types of traffic lights, such as a four-color traffic light 512 and a pedestrian traffic light 514, based on the attribute values of the vertex included in the high-definition road map data and may place the respective traffic lights at positions corresponding to the coordinate values of the vertex. The processor may also determine a placement direction of the traffic light. For example, the processor may determine the placement direction of the traffic light in consideration of the position of the traffic light, surrounding lanes, links, and the like.

According to an example, the processor may associate the traffic light with the travel route. For example, the processor may associate green and red signals of the four-color traffic light 512 with straight-travel routes 520, 530, 540 of lanes among a plurality of lanes along which straight travel is possible. The processor may also associate a left-turn signal of the four-color traffic light 512 with a left-turn travel route 522 of a lane among the plurality of lanes along which left turns are possible. Additionally, the processor may associate a signal of the pedestrian traffic light 514 with a right-turn travel route 542 of a lane among the lanes along which right turns are possible. The vehicle may determine whether to travel or stop depending on a change of the traffic-light signal with reference to the travel route associated with the four-color traffic light 512.

FIG. 5 illustrates one four-color traffic light 512 and one pedestrian traffic light 514 that are associated with a plurality of lanes in one direction, but the present disclosure is not limited thereto. For example, a traffic light placed at an intersection may further include a traffic light having an identical or related signal cycle. That is, a four-color traffic light having an identical signal cycle may be further placed at a position opposite to the four-color traffic light 512 in one direction. In addition, the traffic lights at the intersection may further include a plurality of traffic lights whose signal cycles are related. That is, a plurality of traffic lights whose signal cycles are related may be placed in the north-south direction with traffic lights in the east-west direction at the intersection. In this case, traffic lights in each direction may be associated with travel routes/links of a plurality of lanes in respective directions.

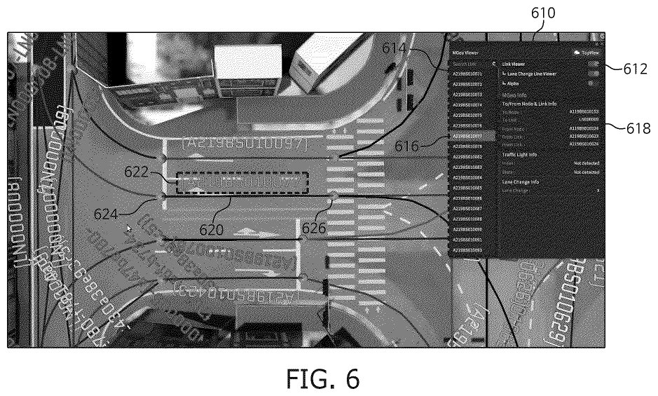

FIG. 6 illustrates an example in which metadata is visualized and displayed in a three-dimensional virtual environment according to an example of the present disclosure. As shown, the user may check a link list 614 that includes a plurality of link identifiers through a metadata-viewer interface 610. The user may also check a plurality of links visualized within the three-dimensional virtual environment.

In an example, by selecting a link-visualization/non-visualization button 612 of the metadata-viewer interface 610, for example, by clicking, the user may visualize a plurality of links within the three-dimensional virtual environment. In this case, nodes and link identifiers associated with the plurality of links may be visualized together within the three-dimensional virtual environment. Conversely, by again selecting the link-visualization/non-visualization button 612, for example, by clicking, the user may remove the plurality of links, nodes, and link identifiers visualized within the three- dimensional virtual environment.

In an example, the user may check the plurality of link identifiers through the link list 614 of the metadata-viewer interface 610. The link list 614 may be displayed in a first region of the display. When the user selects a specific link in the link list 614, the user may check node and link information 618 associated with a selected link 616 in the metadata-viewer interface 610. The node and link information 618 associated with the selected link 616 may be displayed in a third region of the display. Here, the node and link information 618 associated with the selected link 616 may include identifiers of a start node and an end node of the selected link 616, an identifier of the selected link 616, and identifiers of other links connected to the selected link 616.

In an example, when the user selects a specific link in the link list 614, a three-dimensional virtual environment near the selected link 616 may be rendered and output on the display. For example, the three-dimensional virtual environment may be rendered and output on the display so that a visualized link 620 of the selected link 616 is located at a center of the display. The rendered three-dimensional virtual environment may be displayed in a second region of the display (for example, a region of the display except for a region in which the metadata-viewer interface 610 is displayed). The user may check the visualized link 620 of the selected link 616 in the three-dimensional virtual environment. Additionally, the user may check a visualized link identifier 622, a visualized associated start node 626, and a visualized associated end node 624 in the three-dimensional virtual environment.

In an example, when the user selects a visualized specific link or a visualized specific link identifier in the region in which the three-dimensional virtual environment is rendered (for example, the second region of the display), the specific link selected in the link list 614 of the metadata-viewer interface 610 may be automatically selected. In addition, the user may check nodes and link information associated with the selected specific link in the metadata-viewer interface 610.

Through this configuration, by visualizing metadata, the user may easily check how the metadata is implemented on the three-dimensional virtual environment. In addition, the user may conveniently check information associated with a specific link using the metadata-viewer interface. Furthermore, by checking a location of a specific link in the three-dimensional virtual environment, the user may promptly find whether an error that occurred during traveling using the autonomous-driving algorithm was caused by the high-definition road map data or by another issue.

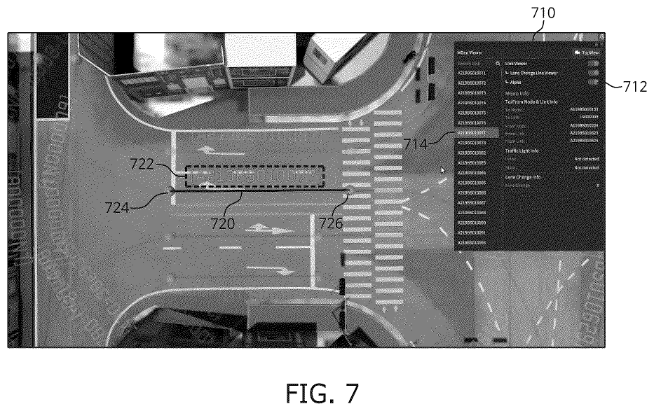

FIG. 7 illustrates an example of adjusting transparency of visualized metadata according to an example of the present disclosure. In an example, by selecting a link-transparency-adjustment on/off button 712 of the metadata-viewer interface 710, for example, by clicking, the user may adjust transparency of links visualized in the three-dimensional virtual environment. Specifically, transparency of visualized links other than a visualized specific link 720 selected by the user may be changed to a predefined value (for example, 70%). The transparency value may be changed by the user. Alternatively, visualized links other than the visualized specific link may be removed from a three-dimensional virtual screen.

For example, when the user selects the link-transparency-adjustment on/off button 712, visualized links other than the visualized link 720 of the selected link 714 may be displayed in the three-dimensional virtual environment with a predetermined transparency value. In addition, a visualized link identifier 722 associated with the selected link 714, a visualized associated start node 726, and a visualized associated end node 724 may remain in the three-dimensional virtual environment without the predetermined transparency value being applied. Accordingly, because the visualized specific link is emphasized, the user may easily identify, on the three-dimensional virtual screen, a link of interest and nodes associated therewith and a link identifier associated therewith.

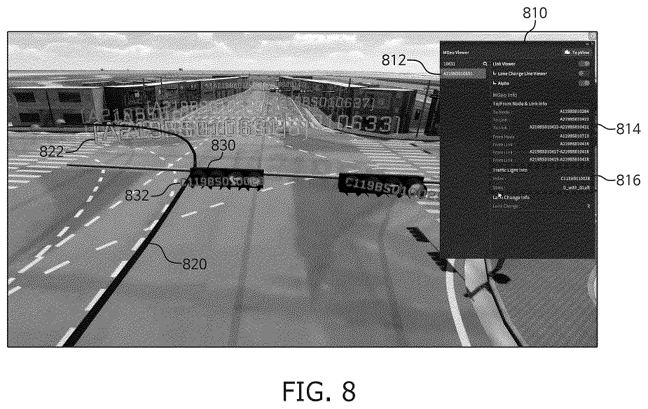

FIG. 8 illustrates an example in which traffic-light information is displayed in a three-dimensional virtual environment according to an example of the present disclosure. In an example, when a link connected or associated with a traffic light is selected in the metadata-viewer interface 810, the user may check node and link information 814 associated with a selected link 812 and traffic-light information 816 associated with the selected link 812 together. The traffic-light information 816 associated with the selected link 812 may be displayed in a fourth region of the display. Here, the traffic-light information 816 associated with the selected link 812 may include a traffic-light identifier and a lighting state of the traffic light (for example, a straight-direction indicator, a left-turn indicator, and the like).

In an example, a traffic-light identifier may be visualized and displayed in the three-dimensional virtual environment. Specifically, the user may check a visualized link 820 associated with the selected link 812, a visualized link identifier 822, and a visualized traffic-light identifier 832 associated with the selected link 812 in the three-dimensional virtual environment. In this case, the traffic-light identifier 832 may be located on a visualized traffic light 830 in the three-dimensional virtual environment.

In an example, when the user selects a visualized traffic light or traffic-light identifier in the three-dimensional virtual environment, the user may check links and nodes associated with the traffic light in the link list of the metadata-viewer interface 810. In addition, the user may check the identifier and lighting state of the traffic light in the metadata-viewer interface 810 (in the fourth region of the display).

In an example, when the user selects the link-transparency-adjustment on/off button of the metadata-viewer interface 810, transparency of visualized links and visualized traffic-light identifiers in the three-dimensional virtual environment may be adjusted. Specifically, except for a visualized specific link and a visualized traffic-light identifier associated with the visualized specific link, the rest of the visualized links, visualized nodes, and visualized traffic-light identifiers may be displayed in the three-dimensional virtual environment with a predetermined transparency value. Alternatively, except for a visualized specific link, a visualized node associated with the visualized specific link, and a visualized traffic-light identifier associated with the visualized specific link, the rest of the visualized links, visualized nodes, and visualized traffic-light identifiers may be removed from the three-dimensional virtual environment.

Through this configuration, the user may easily confirm, on a screen on which the three-dimensional virtual environment is rendered, a traffic light connected with a specific link in the three-dimensional virtual environment and a lighting state thereof. In addition, the user may easily confirm whether the autonomous-driving vehicle correctly travels with respect to the traffic light at an intersection.

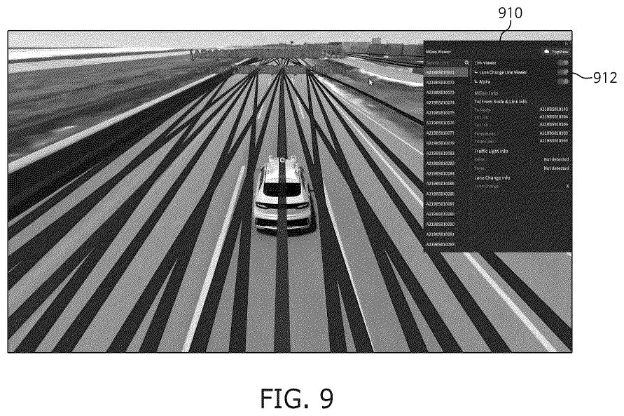

FIG. 9 illustrates an example in which virtual links are displayed in a three-dimensional virtual environment according to an example of the present disclosure. As shown, virtual links may be visualized within the rendered three-dimensional virtual environment. Here, a virtual link may represent a path along which the vehicle may perform a lane change. For example, virtual links along which lane changes can be performed from each lane to another lane may be visualized and output together with the rendered three-dimensional virtual environment.

In an example, by selecting a virtual-link-visualization/non-visualization button 912 of the metadata-viewer interface 910, for example, by clicking, the user may visualize a plurality of virtual links within the three-dimensional virtual environment. Conversely, by again selecting the virtual-link-visualization/non-visualization button 912, for example, by clicking, a plurality of visualized virtual links may be removed from the rendered three-dimensional virtual environment.

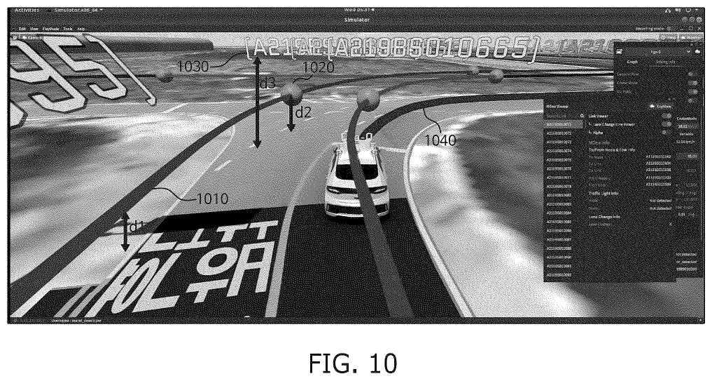

FIG. 10 illustrates an example of displaying links and nodes in a three-dimensional virtual environment according to an example of the present disclosure. As shown, a visualized link 1010, a visualized node 1020, a visualized link identifier 1030, and a planned travel route 1040 of the vehicle may be displayed in the three-dimensional virtual environment. Here, a color of the visualized link 1010 in the three-dimensional virtual environment may differ from a color of other visualized links connected with the visualized link 1010. In addition, although all nodes may be visualized as spheres of an identical color in the three-dimensional virtual environment, the present disclosure is not limited thereto. For example, only nodes existing on the planned travel route 1040 of the vehicle may be visualized as spheres of an identical color.

In an example, the node, the link, and the link identifier may be visualized while being spaced apart from the road. For example, the visualized link 1010 may be visualized at a height d1 above the road. The visualized node 1020 may be visualized at a height d2 above the road. Additionally, the visualized link identifier 1030 may be visualized at a height d3 above the road. Here, the heights d1 and d2 may be identical, and the height d3 may be greater than the heights d1 and d2. Meanwhile, the planned travel route 1040 of the vehicle may be visualized at a height d4 above the road. Here, the height d4 may be lower than the heights d1, d2, and d3.

Through this configuration, the user may readily distinguish, in the three-dimensional virtual environment, between the planned travel route of the vehicle and the visualized link according to a height from the ground surface. Moreover, because the visualized link identifier is displayed higher than the visualized link with reference to the ground surface, the user may more easily identify the link identifier.

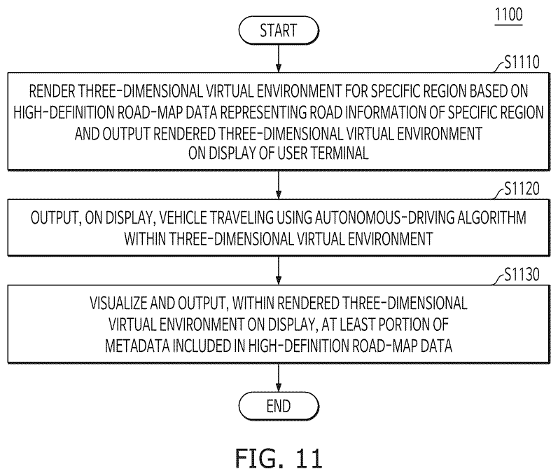

FIG. 11 is a flowchart illustrating an example of a method 1100 for displaying three-dimensional virtual environment information according to an example of the present disclosure. In an example, the method 1100 may be performed by at least one processor of a user terminal. The method 1100 may start with the processor rendering, based on high-definition road map data representing road information of a specific region, a three-dimensional virtual environment for the specific region and outputting the rendered three-dimensional virtual environment on a display of the user terminal S1110. The processor may also output, on the display, a vehicle traveling within the three-dimensional virtual environment using an autonomous-driving algorithm S1120.

Subsequently, the processor may visualize, within the rendered three-dimensional virtual environment, at least a portion of metadata included in the high-definition road map data and output the visualization on the display S1130. Here, the metadata visualized within the rendered three-dimensional virtual environment may include at least one of a link, a node, and a link identifier. In this case, the node may be visualized as a sphere and the link may be visualized as a line connecting two nodes. The link may represent a route along which the vehicle may proceed without changing lanes. Additionally, the metadata visualized within the rendered three-dimensional virtual environment may further include a virtual link. In such a case, the virtual link may represent a path along which the vehicle may perform a lane change.

In an example, the processor may display, in a first region of the display, at least some of a plurality of link identifiers included in the high-definition road map data. The processor may receive a first user input selecting a specific link identifier in the first region of the display. In response to the first user input, the processor may render, in a second region of the display, a three-dimensional virtual environment near the selected specific link and may visualize the specific link and an identifier of the specific link together.

In an example, the processor may receive a second user input related to adjusting transparency of the visualized metadata. In response to the second user input, the processor may display, in the second region of the display, visualized links other than a specific visualized link with transparency changed to a predefined value.

In an example, a color of the specific link visualized in the second region of the display may differ from a color of other visualized links connected to the specific link. All nodes visualized in the second region of the display may be visualized as spheres of an identical color.

In an example, the specific link may be visualized at a first height above the road surface. Nodes associated with the specific link may be visualized at a second height above the road surface. Additionally, an identifier of the specific link may be visualized at a third height above the road surface. In such a case, the first height and the second height may be identical, and the third height may be greater than the first height.

In an example, the processor may display, in a third region of the display, nodes associated with the specific link and information on other links connected to the specific link. The processor may also display, in a fourth region of the display, traffic-light information associated with the specific link. Here, the traffic-light information associated with the specific link may include a traffic-light identifier and a lighting state of the traffic light.

The above-described method may be provided as a computer program stored in a computer-readable recording medium for execution by a computer. The medium may continuously store the computer-executable program or may store it temporarily for execution or download. The medium may be various recording or storage means in a form in which single or multiple hardware are combined, without being limited to a medium directly connected to a computer system, and may exist in a distributed manner on a network. Examples of the medium may include magnetic media such as hard disks, floppy disks, and magnetic tapes; optical recording media such as CD-ROMs and DVDs; magneto-optical media such as floptical disks; and media configured to store program instructions, including ROM, RAM, and flash memory. Other examples of the medium may include recording media or storage media managed by an app store that distributes applications or by other various sites or servers that supply or distribute software.

Methods, operations, or techniques of the present disclosure may be implemented by various means. For example, such techniques may be implemented by hardware, firmware, software, or a combination thereof. Those of ordinary skill in the art will understand that various illustrative logical blocks, modules, circuits, and algorithm steps described in connection with the present disclosure may be implemented by electronic hardware, computer software, or a combination of both. For clarity of description of hardware and software interchangeability, various illustrative components, blocks, modules, circuits, and steps have been generally described above in their functional aspects. Whether such functions are implemented as hardware or software may depend upon design constraints imposed on an overall system and specific applications. Those of ordinary skill in the art may implement the described functions for each specific application in various ways, but such implementation should not be interpreted as departing from the scope of the present disclosure.

In a hardware implementation, processing units employed to perform the techniques may be implemented within one or more ASICs, DSPs, digital-signal-processing devices, programmable logic devices, FPGAs, processors, controllers, microcontrollers, state machines, other electronic units designed to perform the functions described herein, computers, or combinations thereof.

Therefore, various illustrative logical blocks, modules, and circuits described in connection with the present disclosure may be implemented or performed in a general-purpose processor, a DSP, an ASIC, an FPGA or another programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. The processor may also be implemented as a combination of computing devices, for example, a combination of a DSP and a microprocessor, one or more microprocessors in combination with a DSP core, or any other such configuration.

In firmware and/or software implementation, the techniques may be implemented as instructions stored on a computer-readable medium such as RAM, ROM, NVRAM, PROM, EPROM, EEPROM, flash memory, compact disc (CD), or magnetic or optical data-storage devices. The instructions may be executed by one or more processors and may cause the processor(s) to perform certain aspects of the functions described herein.

When implemented in software, the techniques may be stored on or transmitted through a computer-readable medium as one or more instructions or codes. Computer-readable media include both storage media and communication media that facilitate transfer of computer programs from one place to another. Storage media may be any available media accessible by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Any connection is properly termed a computer-readable medium.

For example, software may be transmitted from a website, server, or other remote source using coaxial cables, fiber-optic cables, twisted-pair cables, digital subscriber line (DSL), or infrared, radio, and microwave technologies, and such coaxial cables, fiber-optic cables, twisted-pair cables, DSL, or infrared, radio, and microwave technologies are included within the definition of the medium. As used herein, disk and disc include compact discs (CDs), laser discs, optical discs, digital versatile discs (DVDs), floppy disks, and Blu-ray discs, which reproduce data magnetically (disks) or optically with lasers (discs). The above combinations should also be included within the scope of computer-readable media.

A software module may reside in a RAM memory, a flash memory, a ROM memory, an EPROM memory, an EEPROM memory, registers, a hard disk, a removable disk, a CD-ROM, or any other form of storage medium known in the art. An exemplary storage medium can be coupled to a processor so that the processor can read information from or write information to, and, in the alternative, the storage medium may be integral to the processor. The processor and the storage medium can reside in an ASIC, which can reside in a user terminal. In the alternative, the processor and the storage medium may reside as discrete components in a user terminal.

Although aspects of the present disclosure have been described above in connection with one or more standalone computer systems, the present disclosure is not limited thereto and may also be implemented in connection with any computing environment, such as a network or distributed computing environment. Furthermore, aspects of the present disclosure may be implemented on multiple processing chips or devices, and storage may likewise be impacted across multiple devices. Such devices can include PCs, network servers, and portable devices.

Although the present disclosure has been described with reference to certain embodiment(s), various modifications and alterations can be made within the scope of the present disclosure that would be apparent to those of ordinary skill in the art. Such modifications and alterations should be considered to be within the scope of the appended claims.

What is claimed is:

1. A method performed by a user terminal comprising at least one processor, the method comprising:
rendering, by the at least one processor, a three-dimensional virtual environment for a specific region based on road map data representing road information of the specific region, wherein a resolution associated with the road map data satisfies a threshold resolution;
outputting the rendered three-dimensional virtual environment on a display of the user terminal;
outputting, on the display, a vehicle traveling using an autonomous driving algorithm within the three-dimensional virtual environment; and
visualizing and outputting, within the rendered three-dimensional virtual environment on the display, at least a portion of metadata included in the road map data.

2. The method as claimed in claim 1, wherein:
the metadata visualized within the rendered three-dimensional virtual environment comprises at least one of a link, a node, and a link identifier,
the node is visualized as a sphere,
the link is visualized as a line connecting two nodes, and
the link represents a route that is configured for the vehicle to travel without changing lanes.

3. The method as claimed in claim 2,
wherein visualizing and outputting at least the portion of the metadata within the rendered three-dimensional virtual environment on the display further comprises:
displaying at least one of a plurality of link identifiers included in the road map data in a first region of the display;
receiving a first user input selecting a specific link identifier of a specific link from the first region of the display; and
based on receiving the first user input, rendering, in a second region of the display, a three-dimensional virtual environment near the selected specific link, and visualizing and displaying the specific link and an identifier of the specific link.

4. The method as claimed in claim 3,
wherein visualizing and outputting at least the portion of the metadata within the rendered three-dimensional virtual environment on the display further comprises:
displaying, in a third region of the display, nodes associated with the specific link and information of other links connected to the specific link.

5. The method as claimed in claim 3,
wherein visualizing and outputting at least the portion of the metadata within the rendered three-dimensional virtual environment on the display further comprises:
displaying, in a fourth region of the display, traffic light information associated with the specific link, and
the traffic light information associated with the specific link comprises a traffic light identifier and a lighting state of a traffic light.

6. The method as claimed in claim 3,
wherein visualizing and outputting at least the portion of the metadata within the rendered three-dimensional virtual environment on the display further comprises:
receiving a second user input associated with adjusting transparency of the visualized metadata; and
based on receiving the second user input, displaying, in the second region of the display, remaining visualized links, except for the specific visualized link, with transparency adjusted to a predefined value.

7. The method as claimed in claim 2, wherein:
the metadata visualized within the rendered three-dimensional virtual environment further comprises a virtual link, and
the virtual link represents a path along which the vehicle is configured to perform a lane change.

8. The method as claimed in claim 3, wherein:
a color of the specific link visualized in the second region of the display differs from a color of other visualized links connected to the specific visualized link,
all nodes visualized in the second region of the display are visualized as spheres of an identical color,
the specific link is visualized at a first height above a road surface,
nodes associated with the specific link are visualized at a second height above the road surface,
an identifier of the specific link is visualized at a third height above the road surface,
the first height and the second height are identical, and
the third height is greater than the first height.

9. A non-transitory computer-readable recording medium storing instructions for execution by one or more processors of at least one computing device, wherein the instructions are configured to, when executed by the one or more processors, cause the at least one computing device to perform the method according to claim 1.

10. A user terminal comprising:
a communication interface;
a memory;
a display; and
at least one processor coupled to the memory and configured to execute at least one computer-readable program stored in the memory,
wherein the at least one computer-readable program comprises instructions that, when executed by the at least one processor, cause the user terminal to:
render a three-dimensional virtual environment for a specific region based on road map data representing road information of the specific region, wherein a resolution associated with the road map data satisfies a threshold resolution;
output the rendered three-dimensional virtual environment on the display of the user terminal;
output, on the display, a vehicle traveling using an autonomous driving algorithm within the three-dimensional virtual environment; and
visualize and output, within the rendered three-dimensional virtual environment on the display, at least a portion of metadata included in the road map data.
